(19) United States
(12) Patent Application Publication
(10) Pub. No.: US 2008/0122235 A1
(43) Pub. Date: May 29, 2008

(54) Door Painting handles

(76) Inventor: Daryl Bauer, Manteca, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/605,816

(22) Filed: Nov. 29, 2006

(51) Int. Cl. B65G 7/12; B05D 1/02

(52) U.S. Cl. 294/158; 427/424

(57) ABSTRACT

A door painting handle system comprises a pair of special handles used as a tool to pick up a wet door and put it somewhere else for drying. Two different handles are used to attach to the door where contact will cause minimal disturbance to the wet paint. One handle has a large pin that slips into the empty hole provided for the door locksets. The other handle has three of four spikes that are pressed into the screw holes predrilled for one of the door hinge plates. The two handles together allow a worker to lift the door without disturbing wet painted finish surfaces.

### FIELD OF THE PRESENT INVENTION

The present invention relates to painting tools, and in particular to handles that allow workers to lift and carry freshly painted house doors with disturbing the wet paint.

### BACKGROUND

Painting can always be messy, and spray painting can especially be troublesome with its overspray that seems to get everywhere. Finished houses have floors, carpets, walls, furniture, and such that need protection from paint spray if it's to be done inside. One way to protect them is to bag or cover the collateral objects, the other way is to remove or enclose the paint spraying in a booth.

Aside from the problems of overspray, painting doors is not so easy. They are large, awkward, and sometimes very heavy. All sides and edges need to be painted, and that leaves nowhere to grip or support the door until it is dry.

What is needed is a way to paint a door on-site and easily, to control any overspray, and to be able to pick up a wet door and to put it somewhere else to dry.

### SUMMARY OF THE PRESENT INVENTION

Briefly, a door painting system embodiment of the present invention comprises a pair of special lifting handles used together as a tool to pick up a freshly painted door and put it elsewhere for drying. Two different types of handles are used to attach to the door, each contact will cause minimal disturbance to the wet paint. One handle has a large pin that slips into the empty hole provided for the door locksets. The other handle has three of four spikes that are pressed into the screw holes predrilled for one of the door hinge plates. The two handles together allow a worker to lift the door without touching the finished wet paint surfaces.

A method of the invention includes the steps: painting a house door; lifting the door while still wet with handles that plug into an empty lockset hole and another that has spikes to spear an empty hinge plate area; and placing the door elsewhere for drying.

An advantage of the present invention is a method is provided to handle a freshly painted door without disturbing the paint.

Another advantage of the present invention is a painting tool is provided that is easy to use and to carry to the next job.

A further advantage of the present invention is a painting tool is provided that allows all sides of a house door to be spray painted in one operation.

The above summary of the present invention is not intended to represent each disclosed embodiment, or every aspect, of the present invention. Other aspects and example embodiments are provided in the figures and the detailed description that follow.

### BRIEF DESCRIPTION OF THE DRAWINGS

The present invention may be more completely understood in consideration of the following detailed description of various embodiments of the present invention in connection with the accompanying drawings, in which:

FIG. 1 is a perspective view diagram of door painting tool system embodiment of the present invention;

FIGS. 2A and 2B, respectively, are front and side view diagrams of lockset-hole handle embodiment of the present invention;

FIG. 3A-3C, respectively, are front, side, and end view diagrams of hinge spike handle embodiment of the present invention; and

FIG. 4 is a side view diagram of a portable painting tent that has been used to paint a house door inside. The handles in FIGS. 2A, 2B, 3A-3C, can be used to remove such door while the paint is still wet.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention as defined by the appended claims.

### DETAILED DESCRIPTION

Very often a freshly painted door cannot be left where it was painted until the paint dries. It needs to be lifted off and moved someplace where it will not be disturbed, e.g., overnight in a dust-free, out-of-the-way area. The problem is, how to pick up a door when there is wet-paint on every location where a worker would normally grab hold of it.

A door painting system embodiment of the present invention comprises a pair of special lifting handles used together as a tool to pick up a freshly painted door and put it elsewhere for drying. Two different types of handles are used to attach to the door, each contact will cause minimal disturbance to the wet paint. One handle has a large pin that slips into the empty hole provided for the door locksets. The other handle has three of four spikes that are pressed into the screw holes predrilled for one of the door hinge plates. The two handles together allow a worker to lift the door without touching the finished wet paint surfaces where such contact would be visible after the door is installed.

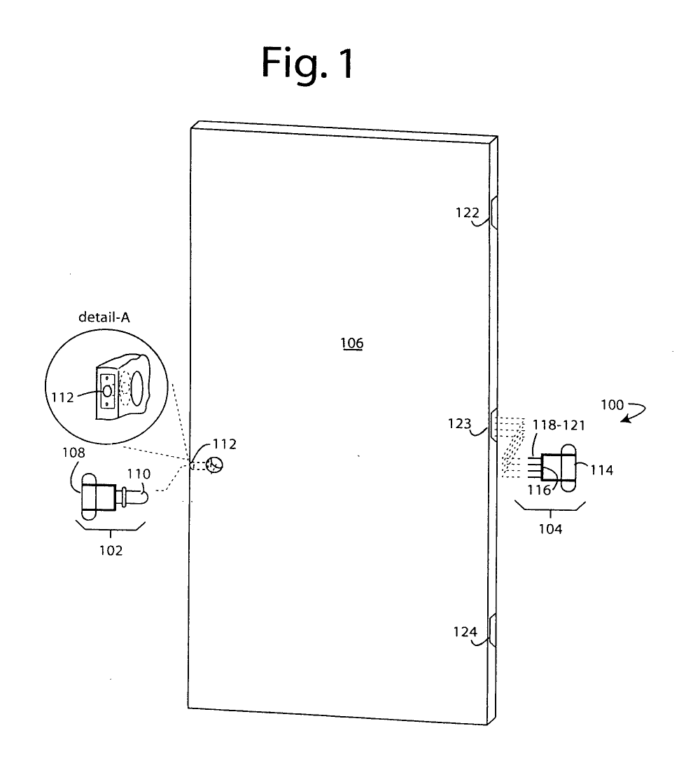

FIG. 1 illustrates a tool system 100 comprising a pair of grips 102 and 104 for handling a typical door 106 with wet painted surfaces. The first grip 102 has a handle 108 for lifting and a large pin 110 that slips snuggly into a lockset hole 112 on the door 106. The second grip 104 also has a handle 114 for lifting, and a plate 116 with several sharp spikes 118-121 that press into the pre-drilled screw holes of any of hinge plate areas 122-124.

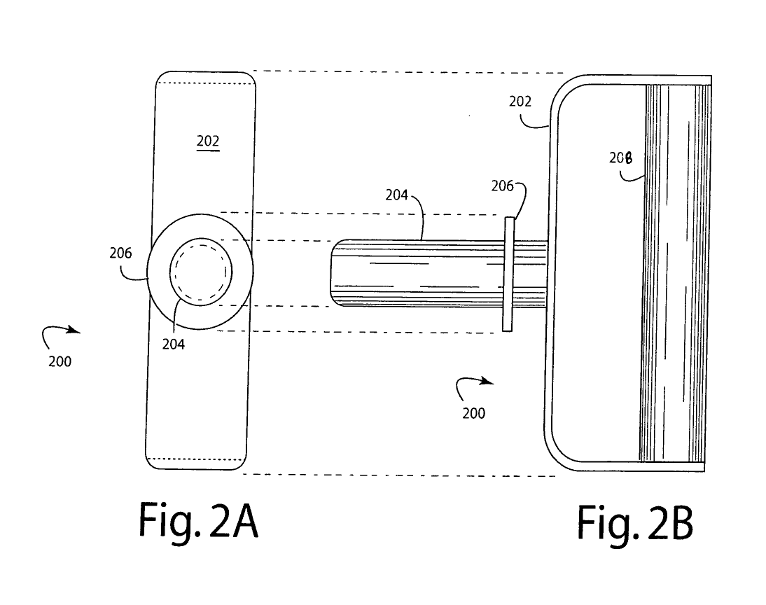

FIGS. 2A and 2B represent a lockset-hole handle embodiment of the present invention, and is referred to herein by the general reference numeral 200. The handle 200 comprises a gripping portion and a nose pin. More specifically, in the embodiment shown in to FIG. 2A-2B, the handle 200 includes flat u-channel 202 with a large rounded-nose pin 204 and a collar stop 206. A round handle 208 is secured to the u-channel 202 and allows a worker to slip the pin 204 into the empty hole for a lockset in a house door. The whole handle 200 could be cast from a single material like aluminum, resin, hard rubber, or steel. Otherwise, it could be assembled from individually manufactured pieces including wood. In one embodiment, the pin 204 is about 0.875 inches in diameter, and handle 208 is one inch round and five inches long. The details of the shape of the gripping area of the embodiment, the pin, and the materials used in construction, may be varied as required, and any such variations are comprehended by the invention.

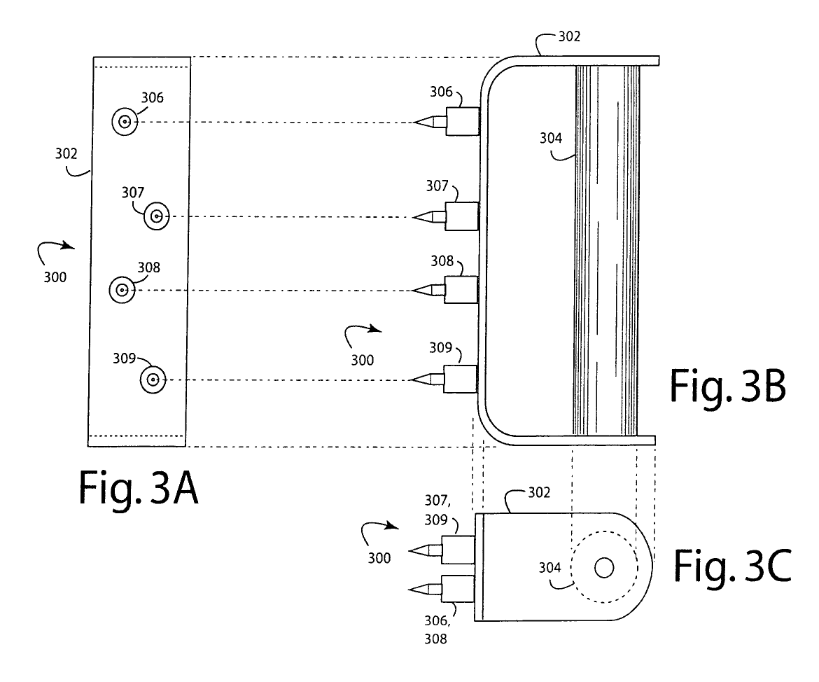

FIGS. 3A-3C represent a hinge spike handle embodiment of the present invention, and is referred to herein by the general reference numeral 300. The hinge spike handle 300 comprises a u-channel 302, a round handle 304, and four spikes 306-309. These spikes are set in a pattern that matches the standard staggered patterns for mounting screws in typical house door hinge plates. In use, these four spikes 306-309 are pressed into pre-drilled screw holes on a door that has been painted. This handle 300, and the other handle 200, can then be used in combination by a worker to move the painted door before it dries. The details of the shape of the gripping area of the embodiment, the spikes, and the materials used in construction, may be varied as required, and any such variations are comprehended by the invention.

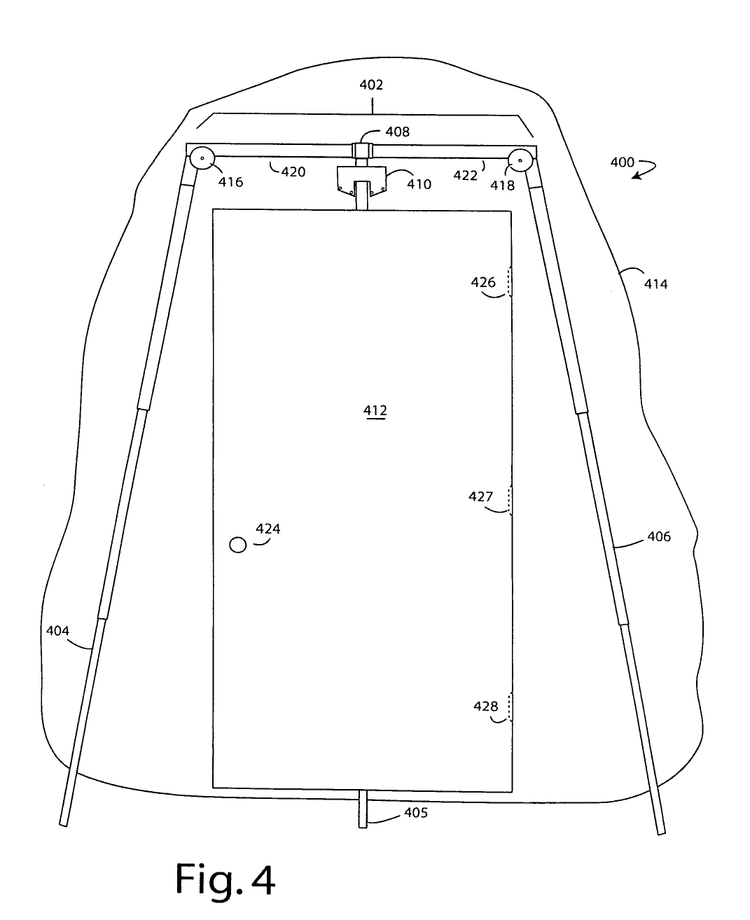

FIG. 4 represents portable painting tent embodiment of the present invention, and is referred to herein by the general reference numeral 400. The painting tent 400 comprises a tripod 402 with telescoping legs 404-406 and a swivel hanger 408. A door hanger bracket 410 hooks up under the swivel hanger 408. Such bracket 410 is screwed onto the top of a house door 412 that has been removed for painting. A shroud or cover 414 drapes over tripod 402 and controls overspray when spray painting door 412. Plastic sheeting is placed below on the floor. The swivel hanger 408 and door hanger bracket 410 allow the painter to get to the front, back, and sides of the door for spraying paint. Elbows 416 and 418, and a third one not shown in FIG. 4, allow the legs 404-106 to be folded up and tucked under arms 420 and 422 for storage. The door 412 typically includes a lockset hole 424, and three relief's 426-428 for the hinge plates. These are where handles 200 and 300, respectively are used to move the door 412. The grips 102 and 104 may be used to move the door into the painting tent for painting, and out of the painting tent for drying and installation.

While the present invention has been described with reference to several particular example embodiments, those skilled in the art will recognize that many changes may be made thereto without departing from the spirit and scope of the present invention, which is set forth in the following claims.

What is claimed is:

1. A wet painted-door handling system, comprising:
a first grip handle for insertion into an empty lockset hole after a door is painted and while still wet; and
a second grip handle for spearing a hinge plate area of said door with spikes;
wherein a freshly painted door can be lifted by both handles, without disturbing wet painted finish surfaces of said door.

2. The wet painted-door handling system of claim 1, wherein said first grip handle comprises:
a u-channel frame having two parallel ears and a middle section;
a hand grip mounted to and spanning between said two parallel ears at distal ends of said parallel ears; and
a pin coupled to said u-channel frame, said pin sized to fit an empty hole provided in a door for installation of lockset hardware.

3. The wet painted-door handling system of claim 2, wherein said pin of said first grip handle further comprises a stop collar disposed on said pin to stop wet paint from contacting said u-channel frame.

4. The wet painted-door handling system of claim 1, wherein said second grip handle comprises:
a u-channel frame having two parallel ears and a middle section;
a hand grip mounted to and spanning between said two parallel ears at distal ends of said parallel ears; and
a number of parallel spikes extending from said middle section of said u-channel frame, said spikes being patterned to facilitate insertion into a pre-drilled hinge plate screw area in a newly painted door.

5. The wet painted-door handling system of claim 4, further comprising:
a painting tent in which said house door is painted and then lifted out before drying by using the first and second grip handles to avoid disturbing wet paint on finished surfaces of said newly painted door.

6. A door lifting tool, comprising:
a hand grip coupled to a pin, said pin being shaped and sized to fit an empty hole provided in a house door for its lockset hardware.

7. The door lifting tool of claim 6, wherein said pin has a rounded-nose to facilitate insertion into a newly painted said house door.

8. The door lifting tool of claim 6, wherein said pin further comprises a stop collar disposed on said pin.

9. A door lifting tool comprising:
a hand grip operatively coupled to a number of parallel spikes patterned to facilitate insertion into a pre-drilled hinge plate screw area of a door.

11. A method for painting a door, comprising:
painting a house door;
lifting said door while still wet with a first handle that plugs into an empty lockset hole of said door and another handle that has spikes to spear an empty hinge plate area of said door; and
placing said door elsewhere for drying.

12. The method of claim 11, in preparation comprising:
erecting a portable tent with a swivel inside at a top center of said tent;
hooking a door onto said swivel secured by a bracket coupled onto a top edge of said door; and
spray painting said door within and turning said door on said swivel to allow access to sides and edges of said door through an opening in said portable tent.
